(19) United States
(12) Patent Application Publication
(10) Pub. No.: US 2007/0094227 A1
(43) Pub. Date: Apr. 26, 2007

(54) System and method for clinical decision support

(75) Inventors: Michael Thomas Randazzo, Cary, IL (US); Aravind Revanasiddayya Hiremath, Bangalore (IN); Joseph Benjamin Susai, Lake Barrington, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/394,539

(22) Filed: Mar. 31, 2006

Related U.S. Application Data
(60) Provisional application No. 60/726,536, filed on Oct. 14, 2005.
(60) Provisional application No. 60/726,075, filed on Oct. 12, 2005.

(51) Int. Cl. G06N 7/00

(52) U.S. Cl. 706/59

(57) ABSTRACT

Certain embodiments of the present invention provide a system for clinical decision support including a rules engine and a notification component. The rules engine is capable of processing message data based at least in part on a rule to determine an action. The rule is user-configurable. The notification component is capable of initiating a notification based at least in part on the determined action.

### BACKGROUND OF THE INVENTION

The present invention generally relates to clinical decision support. More specifically, the present invention relates to systems and methods for clinical business decision support.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), laboratory information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Clinical decision support systems provide assistance to healthcare providers such as physicians. For example, clinical decision support systems can aid a physician in making decisions regarding diagnosis and/or treatment. As another example, clinical decision support systems may perform interaction checking on prescription orders for possible adverse drug interactions. A clinical decision support system may be part of a clinical information system (CIS) and/or hospital information system (HIS), for example. A clinical decision support system may utilize information stored in and/or received from other systems such as RIS, CVIS, PACS, LIS, and EMR.

Current clinical decision support systems are predefined, inflexible, and not configurable. That is, current systems do not allow users such as physicians to define rules and configure existing rules. That is, current systems require administrative and/or engineering resources and/or personnel to build rules and deploy a clinical decision support system. In addition, current decision support systems use complex and confusing syntax to write code using Booleans and database schema to cover situations, precluding non-technical users from developing rules. Thus, there is a need for a flexible clinical decision support. Further, there is a need for an easy to use interface for specifying and modifying rules for a clinical decision support system.

The Health Insurance Portability and Accountability Act (HIPAA) provides for a variety of requirements for the protection of the privacy of patients. For a variety of reasons, including patient privacy and HIPAA requirements, there is a need for systems and methods to protect patient privacy in CIS and/or HIS applications.

### BRIEF SUMMARY OF THE INVENTION

Certain embodiments of the present invention provide a system for clinical decision support including a rules engine and a notification component. The rules engine is capable of processing message data based at least in part on a rule to determine an action. The rule is user-configurable. The notification component is capable of initiating a notification based at least in part on the determined action.

In an embodiment, the rule is user-defined. In an embodiment, the rule includes a temporal condition. In an embodiment, the rule can be overridden based at least in part on user identity. In an embodiment, the notification component is capable of generating an order based at least in part on the determined action. In an embodiment, the notification is based at least in part on a notification template. The notification template defines one or more notification formats based at least in part on a medium of notification. In an embodiment, the notification is sent to a plurality of recipients. In an embodiment, the notification includes patient information based at least in part on privacy parameters. Certain embodiments include an alert manager. The alert manager is capable of receiving the notification. In an embodiment, the alert manager is capable of ordering a plurality of received notifications. In an embodiment, the alert manager is capable of allowing a user to acknowledge the notification. Certain embodiments include a rule interface. The rule interface is capable of at least one of defining, manipulating, and deleting the rule. In an embodiment, the rule interface is capable of defining the rule based at least in part on a rule template. The rule template defines a structure for a rule including at least one of a condition component and an action component. In an embodiment, The rule interface is capable of allowing a user to define a rule using at least in part a graphical interface. Certain embodiments include a processing component. The processing component is capable of episode management based at least in part on the determined action. The episode management includes tracking activity from detection of a problem to resolution of the problem.

Certain embodiments of the present invention provide a method for clinical decision support including receiving message data at a rules engine, determining an action, and initiating a response. The rules engine is capable of processing message data based at least in part on a rule. The rule is user-configurable. The action is determined based at least in part on the message data and the rule. The response is initiated based at least in part on the determined action.

In an embodiment, the response includes generating an order. Certain embodiments include defining a rule with a rule interface. In an embodiment, the rule is based at least in part on a rule template.

Certain embodiments of the present invention provide a computer-readable medium including a set of instructions for execution on a computer, the set of instructions including a rules engine routine and a notification routine. The rules engine routine is configured to determine an action based at least in part on message data and a rule. The rule is user-configurable. The notification routine is configured to initiate a notification based at least in part on the determined action.

### BRIEF DESCRIPTION OF SEVERAL VIEWS OF THE DRAWINGS

FIG. 1 illustrates a system for clinical decision support used in accordance with an embodiment of the present invention.

FIG. 2 illustrates an interface for rule management used in accordance with an embodiment of the present invention.

FIG. 3 illustrates a flow diagram for a method for clinical decision support used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

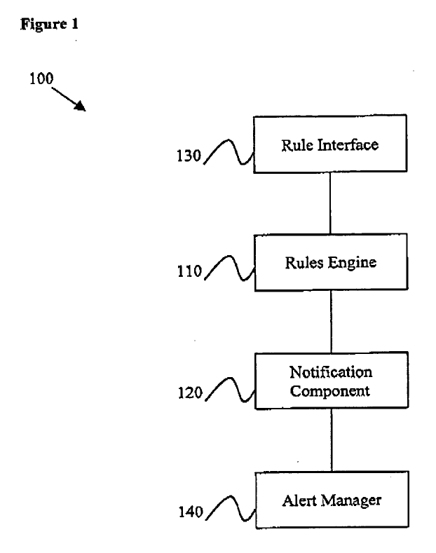

FIG. 1 illustrates a system 100 for clinical decision support used in accordance with an embodiment of the present invention. The system 100 includes a rules engine 110 and a notification component 120. In certain embodiments, the system 100 includes a rule interface 130. In certain embodiments, the system 100 includes an alert manager 140.

The rules engine 110 is in communication with the notification component 120. If present, the rule interface 130 is in communication with the rules engine 110. If present, the alert manager 140 is in communication with the notification component 120.

In operation, the rules engine 110 receives message data. The message data may be received from, for example, a pharmacy system, a lab system, an order management system, an admission discharge transfer (ADT) system, RIS, PACS, LIS, EMR, and/or other parts of a hospital information system (HIS). The message data may be received over a computer network or other communications interface, for example. The message data may conform, at least in part, to the HL7 protocol or other communications protocol, for example. The message data may indicate, for example, a lab result has become available for Patient A. As another example, the message data may indicate an x-ray procedure has been ordered for Patient B.

The rules engine 110 processes and/or evaluates the message data based at least in part one or more rules. In an embodiment, one or more rules are user-configurable. That is, the rule(s) may be configured, adjusted, and/or modified by a user. In an embodiment, the rule(s) is/are user-defined. That is, the rule(s) may be created, defined, and/or specified by a user. Alternatively, one or more rules may be automatically configured using software, for example. A user may be, for example, an administrator, physician, nurse, or other healthcare provider.

A rule includes a condition component and an action component. The condition component of the rule is evaluated by the rules engine 110. If the rules engine 110 determines that the condition component of the rule is met, the rules engine 110 may then determine that the action component is to be effected. For example, a rule may include “if patient's potassium level drops by ten percent, then page patient's attending physician.” In this example, the conditional component is “patient's potassium level drops by ten percent” and the action component is “page patient's attending physician.” This rule may be evaluated when a lab result is received at the rules engine 110, for example. It should be understood that either or both of the condition component and the action component may be substantially more complex than this example; this example is simplified for clarity. As another example, a rule may include “if a patient's heart rate is less than 60 beats per minute AND the patient is taking the medication Digoxin, then page the attending physician AND flag all Digoxin orders on the patient's order review screen.” This rule illustrates a variety of condition component and action component capabilities, including, for example, evaluating a patient's medication and flagging orders related to the patient.

The condition component may include several factors and/or variables to be evaluated with various dependencies between them. Dependencies may include, for example, Boolean operators such as “AND,” “OR,” and “NEITHER.” The condition component may include a variety of conditions specified by an expression or operator such as “equal to,” “less than,” “greater than,” “drop by %,” and “increased by.” In addition, an expression or operator included in the condition component may include a temporal characteristic. For example, the expression might be “within the past hour” or “over one day ago.”

The action component may include a variety of options and/or events to be effected by, or initiated by, the rules engine 110. For example, one or more users may be notified and/or a user may be notified by different media depending on the determination of the rules engine 110. Thus, for example, the action component may indicate that the treating physician be paged and the referring physician be emailed unless the referring physician is in the hospital, in which case the referring physician may also be paged. The action component may at least in part be effected by the rules engine 110 initiating a notification using a notification component, for example. The notification component may be similar to notification component 120, described below, for example. In certain embodiments, the action component includes writing one or more orders. For example, if the patient's potassium level has dropped by ten percent, the action component may include writing an order to re-test the patient's potassium level in addition to paging the patient's attending physician.

A rule may be implemented as a table, interpreted code, database query, or other data structure, for example. A rule may be represented in a variety of ways known to one having ordinary skill in the art. A rule may be implemented as content in a database, for example. The database may store, for example, a rule type, criteria, operator, and value. The database may contain a rule identifier with one to many criteria pairs such as “criteria=Potassium, operator=drops, value=10%,” for example.

A rule may be specified at the site level. For example, one or more rules may be defined for a site, such as a clinic or hospital, that relate to general operating procedures. As an example, a rule, similar to the rule discussed above, may be specified to monitor the potassium level for all patients. A rule may be defined for a specific patient and/or group of patients. For example, one or more rules may be defined that are specific to a particular patient. As another example, one or more rules may be defined that are specific to a group of patients, such as those in an intensive care unit (ICU). These more specific rules may have condition components that are targeted to the particular condition and/or situation of the particular patient or group of patients. It should be noted that rules that are more general in nature may still be triggered on a per-patient basis. That is, for example, a general rule relating to potassium levels will still be evaluated in the context of each individual patient. More specific rules may only be evaluated in the context of patients that fit within the constraints of those rules. For example, a rule specific to patients in the ICU may not be evaluated for patients not in the ICU. In an embodiment, a rule may be specific to a user, such as a physician or other healthcare practitioner, or a group of users. For example, a rule may be specified so that a practitioner is notified by a page whenever lab results are available for any patient's assigned to that practitioner.

The rules engine 110 may process rules asynchronously and/or synchronously. An example of an asynchronously processed rule is a surveillance alert. An example of an synchronously processed rule is a real-time alert during an activity. An asynchronous rule is processed when data comes into the system 100. For example, when a lab value decreases and/or falls below a threshold, a rule is processed asynchronously, without a user being logged into the system. In contrast, a synchronous rule is processed while a users is utilizing the system. For example, a rule may prevent a user after a certain time from ordering an exam as “stat” as there may be no one available to process such an exam.

The notification component 120 is capable of notifying one or more recipients. A recipient may be notified by one or more media. For example, a recipient may be paged and/or emailed. As another example, a recipient may be a software module or program. As another example, a recipient may be a component and/or device such as an alert inbox or message manager. The alert inbox may be similar to alert inbox 140, described below, for example. The notification component 120 may notify a recipient in response to a request and/or initiation from the rules engine 110, for example. The notification to the recipient may include information based at least in part on information from the rules engine 110, for example. For example, the notification may include a patient's name, information about the condition component that was evaluated by the rules engine 110, and/or the evaluation of the condition component that resulted in the initiation of the notification. For HIPAA compliance, certain notifications may not include much information. For example, a message to alert inbox 140 may be displayed in a public area, depending on where a user is logged in. In this case, the notification and/or alert inbox 140 may, based on the location where the alert is being displayed and/or may be displayed, may only include a patient record number and a message to review the patient's results. As another example, a page directly to a physician may include a patient's name and a description of what the notification is regarding. The data in a notification may vary depending on the rule, for example.

The notification may be based at least in part on a notification template, for example. For example, the action component may include a notification template for the notification. The notification template may specify and/or describe the form and/or format the notification should take. The form and/or format may vary based on the medium of the notification. For example, the notification template may specify the format of an email to be sent and/or the format of a textual and/or aural page.

In an embodiment, the notification from the notification component 120 may take into account HIPAA, privacy, and/or confidentiality parameters. Based on the user accessing and/or viewing the information, only an alias and/or patient identification number, may be provided, for example. For example, an email or pager notification, which may be communicated over an insecure network, may only include a patient identification number and/or alias. As another example, an alert sent to an internal hospital alert inbox, which may have more secure access capabilities, may include more details pertaining to the patient's identity and/or condition.

In certain embodiments, a rule interface 130 is present. The rule interface 130 allows a user to define, specify, create, modify, adjust, display, cancel, suspend, override, and/or remove one or more rules included in the rules engine 110. For example, an administrator may define a new rule to be applied to all patients using rule interface 130. As another example, a physician may suspend or override a rule from being evaluated for a particular patient because of the patient's particular condition or circumstances. In an embodiment, the rule interface 130 includes at least in part a point and click and/or graphical interface component. For example, the rule interface 130 may allow a user to build a rule by selecting factors and/or variables to evaluated. As another example, the rule interface 130 may allow a user to drag and drop connections between factors and/or variables to specify a rule. In an embodiment, the rule interface 130 provides one or more rule templates for creating rules. The rule template may define and/or specify a structure for a rule. That is, the rule template may include a basic set of conditions and/or actions useful for a particular category of rules. The rule template may include a condition component and/or an action component. For example, a rule template may be provided for checking lab results. The user may select the rule template, and then specify the particular lab result and deviation from prior results and/or a standard value, for example.

In certain embodiments, the rule interface 130 restricts what a user may do with a rule, or the creation of a rule, based at least in part on the identity of the user. That is, a particular user may only have privileges to create, access, modify, and/or remove particular rules. For example, a nurse may only be able define a rule for a patient under the nurse's care. As another example, a physician may be able to modify a rule for any patient. As another example, an administrator may be able to create a new site-wide rule that is evaluated for all patients.

In certain embodiments, an alert manager 140 is present. The alert manager 140 may be similar to an “inbox” and/or notification manager, for example. The alert manager 140 may be a user interface and/or software, hardware, and/or firmware component that allows a user to manage alerts and/or notifications, for example. The notifications may be received from the notification component 130, described above, for example. A user may be a physician, nurse, or other healthcare provider, for example. Managing alerts and/or notifications may include filtering and/or ordering received alerts and/or notifications, for example. For example, a physician may sort notifications from the notification component 130 with the alert manager 140 by order received. As another example, a physician may filter alerts and/or notifications with the alert manager 140 based on severity, e.g., only showing the highest priority alerts and/or notifications. In certain embodiments, the alert manager 140 is capable of allowing a user to acknowledge and/or respond to one or more notifications and/or alerts. For example, a radiologist may receive a notification that a patient's chest x-ray is available to be read. The physician may acknowledge receipt of the notification with the alert manager 140.

In certain embodiments, the system 100 includes a processing component (not shown) for episode management. The processing component is in communication with the rules engine 110. In an embodiment, the processing component is in communication with the notification component 120. Episode management includes monitoring and/or tracking data pertaining to a patient and/or group of patients from the detection of a problem until the resolution the problem. The processing component may track a treatment plan, medication given, and how a patient is responding based at least in part on message data. Episode management may span across encounters between a patient and a healthcare provider, for example. In certain embodiments, the processing component is included in the rules engine 110.

The components and/or functionality of system 100 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

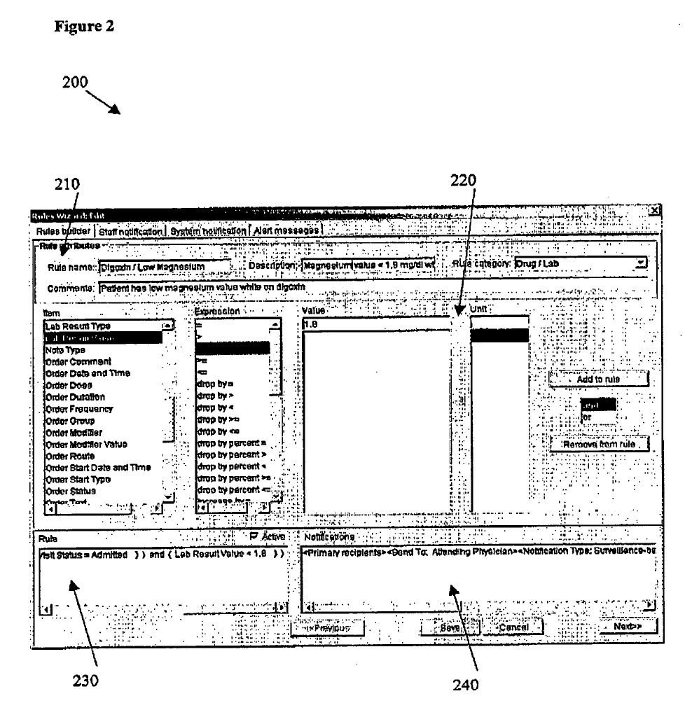

FIG. 2 illustrates an interface 200 for rule management used in accordance with an embodiment of the present invention. Interface 200 may be similar to rule interface 130, described above, for example. For the purposes of the following discussion, interface 200 will be described with capabilities similar to rule interface 130, described above. However, it would be known to one having ordinary skill in the art that other implementations are possible.

As discussed above, interface 200 may be configured to allow a user to create, define, manipulate, adjust, alter, activate, deactivate, cancel, remove, and/or delete one or more rules in a variety of different ways and layouts. A rule and/or components of a rule may be presented, for example, as text, in a table, list, chart, and/or other graphical format. Interface 200 may be configured to allow a user to point and click at least in part to create and/or modify a rule. It should be emphasized that the following discussion of interface 200 is as depicted in FIG. 2, but that other implementations, layouts, and displays are possible and would be known to one having ordinary skill in the art.

interface 200 includes a rule attribute panel 210, a rule configuration panel 220, a rule condition panel 230, and a rule action panel 240. The following discussion of the operation of interface 200 refers to creating a new rule, but modification of an existing rule would be similar and would be understandable by one having ordinary skill in the art based on the following description.

In operation, a user may specify attributes for a rule. Attributes may be specified using the rule attribute panel 210. Attributes may include, for example, a rule name, a description, comments, and/or a category. The category may be used to organize rules, for example.

The user may specify the rule condition component and/or action component for a rule. The condition component and/or action component may be specified using the rule configuration panel 220. For example, the rule configuration panel 220 may include lists, tables, icons, and/or other controls for defining the condition and/or action components of a rule. The rule configuration panel 220 may include a list of items, factors, and/or variables to be evaluated and/or tested as part of the condition component for a rule. For example, a list may include “potassium lab result” as a variable to be used in the condition component of a rule.

The rule configuration panel 220 may allow a user to specify an operator or expression for use in evaluating the item, factor, and/or variable. For example, a list may include “drop by %.” Operators and/or expressions may include, for example, Boolean operators such as “AND,” “OR,” and “NEITHER,” for example. As another example, the operators and/or expression may include a variety of conditions specified by an expression or operator such as “equal to,” “less than,” “greater than,” “drop by %,” and “increased by.” In addition, an expression or operator may include a temporal characteristic. For example, the expression might be “within the past hour” or “over one day ago.”

The rule configuration panel 220 may allow a user to specify a value to be evaluated in the context of the specified factor or variable and the specified operator or expression. For example, a text entry box may allow the user to specify “10” in the context of the above discussed examples, yielding a condition component that specifies “potassium lab result drop by 10%.”

The rule configuration panel 220 may allow a user to specify units for the value. For example, if, instead of a 10% drop, a drop of 1.2 mg/dl was the desired triggering condition, the units for the value may be specified.

Multiple items, factors, and/or variables may be added to the rule being specified using the rule configuration panel 220. For example, the rule may include several factors and/or variables to be evaluated with various dependencies between them. Dependencies may include, for example, Boolean operators such as “AND” and “OR.” Another operator may be the “EXISTS” operator, for example. The “EXISTS” operator may be used to determine if, for example, an order exists or if a patient has a particular allergy.

The rule interface 200 allows a user to specific a variety of options and/or events to be effected or initiated when the condition component is met in the action component of the rule. For example, one or more users may be notified and/or a user may be notified by different media. Thus, for example, the action component may indicate that the treating physician be paged and the referring physician be emailed unless the referring physician is in the hospital, in which case the referring physician may also be paged. In certain embodiments, the action component includes writing one or more orders. For example, if the patient's potassium level has dropped by ten percent, the action component may include writing an order to re-test the patient's potassium level in addition to paging the patient's attending physician.

The current form of the condition component of the rule being specified may be displayed in the rule condition panel 230. The current form of the action component of the rule being specified may be displayed in the rule action panel 240.

The components and/or functionality of interface 200 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

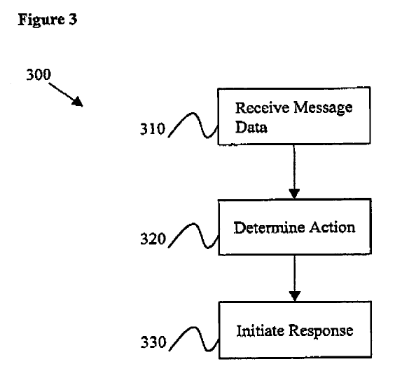

FIG. 3 illustrates a flow diagram for a method 300 for clinical decision support used in accordance with an embodiment of the present invention. The method 300 includes the following steps, which will be described below in more detail. At step 310, message data is received. At step 320, an action is determined. At step 330, a response is initiated. The method 300 is described with reference to elements of systems described above, but it should be understood that other implementations are possible.

At step 310, message data is received. The message data may be received at a rules engine. The rules engine may be similar to rules engine 110, described above, for example. The rules engine is capable of processing message data based at least in part on a rule. The rule may be similar to a rule included in rules engine 110, described above, for example. In an embodiment, the rule is user-configurable. In an embodiment, the rule is user-defined. In an embodiment, the rule is defined and/or configured by software and/or an administrator, for example.

The message data may be received from, for example, a pharmacy system, a lab system, an order management system, an ADT system, RIS, PACS, LIS, EMR, and/or other parts of an HIS. The message data may be received over a computer network or other communications interface, for example. The message data may conform, at least in part, to the HL7 protocol or other communications protocol, for example. The message data may indicate, for example, a lab result has become available for Patient A. As another example, the message data may indicate an x-ray procedure has been ordered for Patient B.

At step 320, an action is determined. The action may be determined by a rules engine. The rules engine may be similar to rules engine 110, described above, for example. The action may be based at least in part on message data. The message data may be the message data received at step 310, described above, for example. The action may be based at least in part on a rule. The rule may be similar to a rule included in rules engine 110, described above, for example.

A rule includes a condition component and an action component. The condition component of the rule is evaluated by the rules engine 110. If the rules engine 110 determines that the condition component of the rule is met, the rules engine 110 may then determine that the action component is to be effected. For example, a rule may include “if patient's potassium level drops by ten percent, then page patient's attending physician.” In this example, the conditional component is “patient's potassium level drops by ten percent” and the action component is “page patient's attending physician.” This rule may be evaluated when a lab result is received at the rules engine 110, for example.

At step 330, a response is initiated. The response may be initiated by a rules engine. The rules engine may be similar to rules engine 110, described above, for example. The response may be initiated based at least in part on a determined action. The determined action may be the action determined at step 320, for example. The determined action may be based at least in part on a rule. The determined action may be based at least in part on the action component of a rule.

The response may include, for example, notifying one or more users. The response may include notifying a user by different media depending on the determination of the rules engine 110 based at least in part on a rule, for example. Thus, for example, the action component of a rule may indicate that the treating physician be paged and the referring physician be emailed unless the referring physician is in the hospital, in which case the referring physician may also be paged. The action component may at least in part be effected by the rules engine 110 initiating a notification using a notification component, for example. The notification component may be similar to notification component 120, described above, for example. In certain embodiments, the initiated response includes writing one or more orders. For example, if the patient's potassium level has dropped by ten percent, the initiated response may include writing an order to re-test the patient's potassium level in addition to paging the patient's attending physician.

In certain embodiments, a rule is defined with a rule interface. The rule interface may be similar to rule interface 130, described above, for example. The rule interface allows a user to define, specify, create, modify, adjust, display, cancel, suspend, override, and/or remove a rule. In an embodiment, the rule interface includes at least in part a point and click and/or graphical interface component. For example, the rule interface may allow a user to drag and drop connections between factors and/or variables to specify a rule.

In an embodiment, the rule is defined and/or specified based at least in part on a rule template. The rule template may define and/or specify a structure for a rule. That is, the rule template may include a basic set of conditions and/or actions useful for a particular category of rules. The rule template may include a condition component and/or an action component. For example, a rule template may be provided for checking lab results. The user may then select the rule template, and then specify the particular lab result and deviation from prior results and/or a standard value, for example. In an embodiment, the action component of the rule template includes a notification template.

One or more of the steps of the method 300 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Claims:

1. A system for clinical decision support, the system including:
a rules engine, wherein the rules engine is capable of processing message data based at least in part on a rule to determine an action, wherein the rule is user-configurable; and
a notification component, wherein the notification component is capable of initiating a notification based at least in part on the determined action.

2. The system of claim 1, wherein the rule is user-defined.

3. The system of claim 1, wherein the rule includes a temporal condition.

4. The system of claim 1, wherein the rule can be overridden based at least in part on user identity.

5. The system of claim 1, wherein the notification component is capable of generating an order based at least in part on the determined action.

6. The system of claim 1, wherein the notification is based at least in part on a notification template, wherein the notification template defines one or more notification formats based at least in part on a medium of notification.

7. The system of claim 1, wherein the notification is sent to a plurality of recipients.

8. The system of claim 1, wherein the notification includes patient information based at least in part on privacy parameters.

9. The system of claim 1, further including an alert manager, wherein the alert manager is capable of receiving the notification.

10. The system of claim 9, wherein the alert manager is capable of ordering a plurality of received notifications.

11. The system of claim 9, wherein the alert manager is capable of allowing a user to acknowledge the notification.

12. The system of claim 1, further including a rule interface, wherein the rule interface is capable of at least one of defining, manipulating, and deleting the rule.

13. The system of claim 12, wherein the rule interface is capable of defining the rule based at least in part on a rule template, wherein the rule template defines a structure for a rule including at least one of a condition component and an action component.

14. The system of claim 12, wherein the rule interface is capable of allowing a user to define a rule using at least in part a graphical interface.

15. The system of claim 1, further including a processing component, wherein the processing component is capable of episode management based at least in part on the determined action, wherein episode management includes tracking activity from detection of a problem to resolution of the problem.

16. A method for clinical decision support, the method including:
receiving message data at a rules engine, wherein the rules engine is capable of processing message data based at least in part on a rule, wherein the rule is user-configurable;
determining an action based at least in part on the message data and the rule; and
initiating a response based at least in part on the determined action.

17. The method of claim 16, wherein the response includes generating an order.

18. The method of claim 16, further including defining a rule with a rule interface.

19. The method of claim 16, wherein the rule is based at least in part on a rule template.

20. A computer-readable medium including a set of instructions for execution on a computer, the set of instructions including:
a rules engine routine configured to determine an action based at least in part on message data and a rule, wherein the rule is user-configurable; and
a notification routine configured to initiate a notification based at least in part on the determined action.
